(19) United States
(12) Patent Application Publication
(10) Pub. No.: US 2011/0077015 A1
(43) Pub. Date: Mar. 31, 2011

(54) Methods, Computer Program Products And Apparatus Providing Shared Spectrum Allocation

(75) Inventors: Mikko Saily, Sipoo (FI); Kari Pajukoski, Oulu (FI); Jari Hulkkonen, Oulu (FI); Esa Tiirola, Kempele (FI)

(73) Assignee: NOKIA CORPORATION, Espoo (FI)

(21) Appl. No.: 12/521,729

(22) PCT Filed: Dec. 28, 2006
(86) PCT No.: PCT/IB07/04132

§ 371 Date: Dec. 7, 2010

(51) Int. Cl. H04W 72/04

(52) U.S. Cl. 455/450

(57) ABSTRACT

In one exemplary embodiment, a method includes: estimating network load for at least one region of a network using a load measurement method (201); using a decision criteria and the estimated network load, determining whether a bandwidth frequency allocation of a dedicated shared bandwidth for the at least one region should be modified, wherein the dedicated shared bandwidth includes bandwidth used by a plurality of systems of the network (202); and in response to determining that the bandwidth frequency allocation should be modified, modifying the bandwidth frequency allocation of the at least one region (203). In another exemplary embodiment, a method includes: providing a dedicated bandwidth to be allocated among a plurality of systems of a network including a first system and a second system; and allocating the dedicated bandwidth such that it includes a first allocation for the first system, a second allocation for the second system and a shared portion.

### TECHNICAL FIELD

The exemplary embodiments of this invention relate generally to wireless communication systems and, more specifically, relate to integration of LTE with other current communication systems (e.g., GERAN).

### BACKGROUND

The following abbreviations are employed:

2G second generation of GSM-based mobile networks

3G third generation of GSM-based mobile networks

3GPP third generation partnership project

ARFN absolute radio frequency class number

BCCH broadcast control channel

BS base station

DAB digital audio broadcasting

DL downlink

DVB digital video broadcasting

EDGE enhanced data rates for GSM evolution

EGPRS enhanced GPRS

ETSI European telecommunications standards institute

E-UTRAN evolved universal terrestrial radio access network

GERAN GSM/EDGE radio access network

GPRS general packet radio services

GSM global system for mobile communications

HSPA high speed packet access

IEEE institute of electrical and electronics engineers

IP internet protocol

LTE long term evolution of UTRAN (E-UTRAN)

MA mobile allocation

MIMO multiple input/multiple output

OFDM orthogonal frequency division multiplexing

RRM radio resource management

SAE system architecture evolution

TCH traffic channel

UE user equipment, such as a mobile station or mobile terminal

UL uplink

UMTS universal mobile telecommunications system

UTRAN universal terrestrial radio access network

WCDMA wideband code division multiple access

Wi-Fi WLAN based on the IEEE 802.11 standard

WiMAX worldwide interoperability for microwave access (IEEE 802.16 standard)

WLAN wireless local area network

LTE (E-UTRAN) describes the evolution of mobile technology that will deliver users the benefits of faster data speeds and new services by creating a new radio access technology that is optimized for IP-based traffic and offers operators a relatively simple upgrade path from 3G networks. Alongside LTE is work on the evolutionary development of the core architecture of mobile networks, called SAE. Together, they will offer operators networks with significant performance enhancements over 3G, with a target of two to four times the spectral efficiency of current 3G/HSPA networks. This means LTE networks will be able to squeeze more bits of data into the same amount of spectrum as 3G and HSPA networks, translating into increased data speeds and/or increased capacity. “LTE—Delivering the optimal upgrade path for 3G networks,” Nokia Press Backgrounder, Oct. 2, 2006.

LTE is the result of ongoing work by the 3GPP, a collaborative group of international standards organizations and mobile-technology companies. 3GPP set out in 1998 to define the key technologies for the 3G, and its work has continued to define the ongoing evolution of these networks. Near the end of 2004, discussions on the longer-term evolution of 3G networks began, and a set of high-level requirements for LTE was defined: the networks should transmit data at a reduced cost per bit compared to 3G; they should be able to offer more services at lower transmission cost with better user experience; LTE should have the flexibility to operate in a wide number of frequency bands; it should utilize open interfaces and offer a simplified architecture; and it should have reasonable power demands on mobile terminals. Standardization work on LTE is continuing, and the first standards are due to be completed in the second half of 2007, with some operators projected to deploy the first LTE networks in 2009. “LTE—Delivering the optimal upgrade path for 3G networks,” Nokia Press Backgrounder, Oct. 2, 2006.

LTE defines new radio connections for mobile networks, and will utilize OFDM, a widely used modulation technique that is the basis for Wi-Fi, WiMAX, and the DVB and DAB digital broadcasting technologies. The targets for LTE indicate bandwidth increases as high as 100 Mbps on the DL, and up to 50 Mbps on the UL. However, this potential increase in bandwidth is just a small part of the overall improvements LTE aims to provide. LTE is optimized for data traffic, and it will not feature a separate, circuit-switched voice network, as in 2G GSM and 3G UMTS networks. “LTE—Delivering the optimal upgrade path for 3G networks,” Nokia Press Backgrounder, Oct. 2, 2006.

The evolution to LTE may be compelling for many operators because of the reduced capital and operating expenditures it requires over previous 3G networks. A key aspect of LTE is its simplified, flat network architecture, derived from it being an all-IP, packet-based network, and the use of new techniques to get high volumes of data through a mobile network. This allows many of the network elements involved in the data transport between an operator's base stations and its core network in current cellular systems to be removed. This not only helps to reduce latency, but also helps to significantly reduce cost, since fewer pieces of network equipment are needed to achieve the same results. Also driving down operators' cost per transmitted bit will be the use of OFDM, which offers relatively high spectral efficiency, and the increased capacity LTE will offer—essentially allowing operators to squeeze more data into the same bandwidth of spectrum. “LTE—Delivering the optimal upgrade path for 3G networks,” Nokia Press Backgrounder, Oct. 2, 2006.

Another important feature of LTE is the amount of flexibility it allows operators in determining the spectrum in which it will be deployed. Not only will LTE have the ability to operate in a number of different frequency bands (meaning operators will be able to deploy it at lower frequencies with better propagation characteristics), but it also features scalable bandwidth. Whereas WCDMA/HSPA uses fixed 5 MHz channels, the amount of bandwidth in an LTE system can be scaled from 1.25 to 20 MHz. This means networks can be launched with a small amount of spectrum, alongside existing services, and adding more spectrum as users switch over. It also allows operators to tailor their network deployment strategies to fit their available spectrum resources, and not have to make their spectrum fit a particular technology. “LTE—Delivering the optimal upgrade path for 3G networks,” Nokia Press Backgrounder, Oct. 2, 2006.

Adding to LTE's appeal for operators using 3GPP-based networks is that it is clearly designed as an evolutionary upgrade, not a technology that demands a completely new system from the ground up. This means that existing network resources can be reused where possible, with particular work going in to minimizing the radio network upgrades required. In addition, a key target is to enable LTE to interwork with 3GPP-based legacy networks, allowing for service continuity. Handovers between LTE and legacy systems will be in place from the outset, allowing for the use of legacy networks to provide fallback coverage. “LTE—Delivering the optimal upgrade path for 3G networks,” Nokia Press Backgrounder, Oct. 2, 2006.

A conventional GERAN network is capable of operation on a 200 kHz resolution. A typical minimum frequency band allocation requirement to operate a GERAN network is 5.0 MHz, which, using a BCCH reuse of 12, gives 12 BCCH carriers (ARFNs) and 13 hopping traffic carriers (ARFNs). In some extreme examples, a GERAN network has been initially deployed with 3.6 MHz, which gives only 6 frequencies for hopping. Note that a tighter BCCH reuse than 12 can also be used as there is no limitation for this in the GERAN specification, however the service quality generally cannot be maintained at an acceptable level for BCCH frequency reuses tighter than 12. In those cases, BCCH DL transmission may be improved with, for example, delay diversity, phase hopping and/or antenna hopping. See, e.g., “Solutions for GSM Narrowband Deployment,” Rivada et al., The 5th International Symposium on Wireless Personal Multimedia Communications, vol. 2, pp. 848-852, Oct. 27-30, 2002; and “Capacity Gain from Transmit Diversity Methods in Limited Bandwidth GSM/EDGE Networks,” Hulkkonen et al., The 57th IEEE Semiannual Vehicular Technology Conference, vol. 4, pp. 2413-2417, Apr. 22-25, 2003.

### SUMMARY

In one exemplary embodiment, a method includes: estimating network load for at least one region of a network using a load measurement method; using a decision criteria and the estimated network load, determining whether a bandwidth frequency allocation of a dedicated shared bandwidth for the at least one region should be modified, wherein the dedicated shared bandwidth comprises bandwidth used by a plurality of systems of the network; and in response to determining that the bandwidth frequency allocation should be modified, modifying the bandwidth frequency allocation of the at least one region.

In another exemplary embodiment, a program storage device readable by a machine, tangibly embodying a program of instructions executable by the machine for performing operations, said operations including: estimating network load for at least one region of a network using a load measurement method; using a decision criteria and the estimated network load, determining whether a bandwidth frequency allocation of a dedicated shared bandwidth for the at least one region should be modified, wherein the dedicated shared bandwidth comprises bandwidth used by a plurality of systems of the network; and in response to determining that the bandwidth frequency allocation should be modified, modifying the bandwidth frequency allocation of the at least one region.

In a further exemplary embodiment, an apparatus including: a memory configured to store a decision criteria; and a processor configured to estimate network load for at least one region of a network using a load measurement method, to use the decision criteria and the estimated network load to determine whether a bandwidth frequency allocation of a dedicated shared bandwidth for the at least one region should be modified, and, in response to determining that the bandwidth frequency allocation should be modified, to modify the bandwidth frequency allocation of the at least one region, wherein the dedicated shared bandwidth comprises bandwidth used by a plurality of systems of the network.

In another exemplary embodiment, an apparatus including: means for estimating network load for at least one region of a network using a load measurement method; means for using a decision criteria and the estimated network load to determine whether a bandwidth frequency allocation of a dedicated shared bandwidth for the at least one region should be modified, wherein the dedicated shared bandwidth comprises bandwidth used by a plurality of systems of the network; and means for modifying, in response to the means for determining that the bandwidth frequency allocation should be modified, the bandwidth frequency allocation of the at least one region.

In a further exemplary embodiment, a method including: providing a dedicated bandwidth to be allocated among a plurality of systems comprising a first system and a second system; and allocating the dedicated bandwidth such that the allocated bandwidth comprises a first allocation for the first system, a second allocation for the second system and a shared portion.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows an exemplary 7.5 MHz wideband deployment in a dedicated frequency spectrum for GERAN and LTE;

FIG. 2 illustrates an exemplary 5.0 MHz narrowband deployment in a dedicated frequency spectrum for GERAN and LTE;

FIG. 3 depicts an exemplary 5.0 MHz narrowband deployment for a shared frequency spectrum for GERAN and LTE utilizing aspects of the exemplary embodiments of the invention;

FIG. 4 shows an exemplary channel allocation for a GERAN minimum allocation (MA sub) and for an extension into the shared portion of the spectrum (MA full);

FIG. 5 shows exemplary DL cell data throughputs for GERAN and LTE on a 5 MHz dedicated frequency spectrum;

FIG. 6 shows exemplary DL cell data throughputs for GERAN and LTE on a 10 MHz dedicated frequency spectrum;

FIG. 7 illustrates a graph of LTE throughput vs. available bandwidth for LTE on a 5 MHz dedicated frequency spectrum for 200 kHz and 600 kHz steps between GERAN and LTE;

FIG. 8 illustrates a graph of LTE throughput vs. available bandwidth for LTE on a 10 MHz dedicated frequency spectrum for 200 kHz and 600 kHz steps between GERAN and LTE;

FIG. 9 shows a simplified block diagram of various electronic devices that are suitable for use in practicing the exemplary embodiments of this invention;

FIG. 10 depicts a flowchart illustrating one non-limiting example of a method for practicing the exemplary embodiments of this invention;

FIG. 11 depicts a flowchart illustrating another non-limiting example of a method for practicing the exemplary embodiments of this invention; and

FIG. 12 depicts a flowchart illustrating another non-limiting example of a method for practicing the exemplary embodiments of this invention.

### DETAILED DESCRIPTION

As utilized herein, the terms service, system, network and technology are used interchangeably to refer to a type of wireless communication system or network utilizing the indicated technology. For example, a GERAN service comprises a wireless network or system that includes or supports GERAN communication. Using this terminology, a network may in fact comprise other networks. For example, an operator network may comprise both a GERAN network and a LTE network.

A LTE service, as currently indicated by 3GPP, is capable of operation on a 180 kHz resolution. Furthermore, the minimum frequency allocation is 1.25 MHz, which includes both common control and traffic. The supported frequency allocations for LTE DL, as specified by Section 7.1.1 of TR 25.814 V7.1.0 (Table 7.1.1-1—Parameters for downlink transmission scheme), are shown in Table 1 below. In addition, the DL synchronization signals, as specified by Section 5.7 of TS 36.211 V0.2.1, are transmitted on 72 active subcarriers, centered around the DC subcarrier. Note also that LTE services may utilize spectrum allocations of different sizes, including 1.25 MHz, 1.6 MHz, 2.5 MHz, 5 MHz, 10 MHz, 15 MHz and 20 MHz in both the uplink and downlink. “UTRA-UTRAN Long Term Evolution (LTE) and 3GPP System Architecture Evolution (SAE), Long Term Evolution of the 3GPP radio technology,” 3GPP, updated Oct. 4, 2006. It is briefly observed that, as specified by Section 6.11 of TS 36.211 V8.1.0 (Dec. 20, 2007), the primary synchronization signal is generated from a frequency-domain Zadoff-Chu sequence and the second synchronization signal is an interleaved concatenation of two length-31 binary sequences.

TABLE 1

| Transmission BW | | 1.25 MHz | 2.5 MHz | 5 MHz | 10 MHz | 15 MHz | 20 MHz |
|---|---|---|---|---|---|---|---|
| Sub-frame duration | | 0.5 ms | | | | | |
| Sub-carrier spacing | | 15 kHz | | | | | |
| Sampling frequency | | 1.92 MHz | 3.84 MHz | 7.68 MHz | 15.36 MHz | 23.04 MHz | 30.72 MHz |
| | | (½ × 3.84 MHz) | | (2 × 3.84 MHz) | (4 × 3.84 MHz) | (6 × 3.84 MHz) | (8 × 3.84 MHz) |
| FFT size | | 128 | 256 | 512 | 1024 | 1536 | 2048 |
| Number of occupied | | 76 | 151 | 301 | 601 | 901 | 1201 |
| sub-carriers †, †† | | | | | | | |
| Number of OFDM | | 7/6 | | | | | |
| symbols per sub frame | | | | | | | |
| (Short/Long CP) | | | | | | | |
| CP length | Short | (4.69/9) × 6, | (4.69/18) × 6, | (4.69/36) × 6, | (4.69/72) × 6, | (4.69/108) × 6, | (4.69/144) × 6, |
| (μs/samples) | | (5.21/10) × 1* | (5.21/20) × 1 | (5.21/40) × 1 | (5.21/80) × 1 | (5.21/120) × 1 | (5.21/160) × 1 |
| | Long | (16.67/32) | (16.67/64) | (16.67/128) | (16.67/256) | (16.67/384) | (16.67/512) |

† Includes DC sub-carrier which contains no data
†† This is the assumption for the baseline proposal. Somewhat more carriers may be possible to occupy in case of the wider bandwidth.

Reference is made to 3GPP TR 25.814 V7.1.0, “3rd Generation Partnership Project; Technical Specification Group Radio Access Network; Physical layer aspects for evolved Universal Terrestrial Radio Access (UTRA) (Release 7),” September 2006, and, more specifically, to the introduction portion of Section 7.1.1, which includes Table 7.1.1-1—Parameters for downlink transmission scheme.

Reference is also made to 3GPP TS 36.211 V0.2.1, “3rd Generation Partnership Project; Technical Specification Group Radio Access Network; Physical Channels and Modulation (Release 8),” November 2006, and, more specifically, to Section 5.7.

Note that although the LTE specifications described herein are accurate as of the drafting and filing of this provisional patent application, the LTE specifications are subject to further revisions, as dictated by the 3GPP. For example, in implementing the exemplary embodiments of the invention, should the 3GPP reduce the minimum allocation for LTE from 1.25 MHz to 0.625 MHz, a similar change may be applied to the discussion of the exemplary embodiments of the invention herein. That is, the non-limiting exemplary embodiments as presented and described herein are not limited solely to utilization of an LTE service having a minimum allocation of 1.25 MHz.

Furthermore, while the exemplary embodiments will be described herein in the context of integrating LTE with GERAN, it should be appreciated that the exemplary embodiments of this invention are not limited for use with only these two particular types of wireless communication systems, and that they may be used in conjunction with other wireless communication systems and implementations. As a non-limiting example, the exemplary embodiments of the invention may be used when integrating otherwise conflicting wireless communication services or systems that use, or have the potential for using, a same dedicated bandwidth, where each of the services or systems has a minimum capacity requirement (e.g., a minimum bandwidth allocation required for operation of the service or system).

When two different and otherwise incompatible systems are allocated to an operator (i.e., an operator network) with dedicated spectrum allocation, there is a relatively high risk that the overall spectral efficiency of one or both systems will be degraded if the two systems are implemented as designed (e.g., based solely on the dedicated spectrum allocations). Thus, it is highly desirable to utilize techniques by which the two opposing systems can peacefully coexist such that the efficiency of one or both systems is diminished as little as possible or at least such that the degradation of efficiency is reduced.

For example, when LTE is initially introduced into an operator network, there may not be sufficiently high penetration of LTE-capable UE. Even so, an operator desiring to integrate LTE must invest to the minimum required capacity in order to launch and operate LTE services. It may even be that the extra LTE capacity is not able to provide revenue for the operator until the LTE UE penetration achieves a certain amount.

If an operator cannot acquire new frequency spectrum to operate LTE, then LTE may be introduced utilizing the same bandwidth as that used for GERAN. That is, if the bandwidth is sufficient to at least accommodate the minimum capacity for both services, then the bandwidth can be divided into different portions for each service.

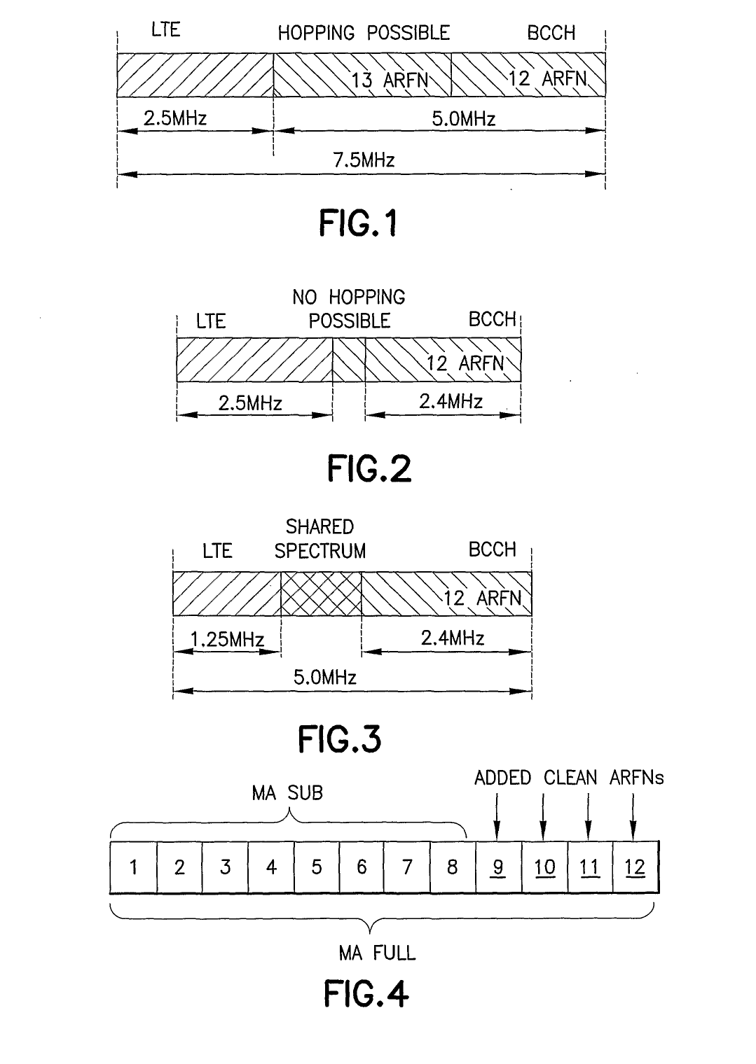

Note that the GERAN service as discussed herein with respect to FIGS. 1-3 comprises a BCCH allocation of 12 ARFN (2.4 MHz) and a desired possible hopping region of 13 ARFN (2.6 MHz). That is, the GERAN service of FIGS. 1-3 has a minimum capacity comprising the BCCH allocation (2.4 MHz). The additional 2.6 MHz of the hopping region significantly increases the efficiency of the GERAN service by enabling the GERAN service to utilize frequency hopping (i.e., when available).

FIG. 1 shows an exemplary 7.5 MHz wideband deployment in a dedicated frequency spectrum for GERAN and LTE. As can be seen, in the exemplary implementation of FIG. 1, the GERAN service is allocated 5.0 MHz of the 7.5 MHz bandwidth while the LTE service is allocated 2.5 MHz. Although the GERAN service may be considered diminished from its previous unshared capacity of 7.5 MHz, the GERAN service of FIG. 1 retains 5.0 MHz of bandwidth and is capable of utilizing frequency hopping if possible.

Although the exemplary implementation of FIG. 1 is useful, it does not address the situation where the bandwidth allocation prevents one of the services from operating at a desired level. FIG. 2 illustrates an exemplary 5.0 MHz narrowband deployment in a dedicated frequency spectrum for GERAN and LTE. In the exemplary implementation of FIG. 2, the GERAN service has been allocated 2.4 MHz for the BCCHs while the LTE service has been allocated 2.5 MHz. This only leaves 0.1 MHz of the bandwidth remaining, which is too little for the GERAN service to utilize for frequency hopping. Thus, the GERAN service of FIG. 2 experiences a significant decrease in capacity as interference diversity is lost (i.e., no hopping layer) and traffic is limited to the BCCH.

Experimentation has shown that in a 5.0 MHz GERAN bandwidth, the allocation of 2.5 MHz for LTE deployment, as shown in FIG. 2, would degrade the GERAN service capacity by 80%. In contrast, experimentation has also shown that in a 5.0 MHz GERAN bandwidth, the allocation of only 1.25 MHz for LTE deployment, the minimum such allocation for LTE, only degrades the GERAN service capacity by 45%. However, in such a case, it may develop that through increased LTE UE penetration, the LTE allocation is insufficient to accommodate all of the LTE traffic.

Thus, it would be desirable to provide techniques by which LTE can be implemented in the same dedicated frequency spectrum as GERAN, preferably with a flexible allocation. In order for both services to operate, the allocation for each would necessarily comprise the minimum frequency allocation required by the service. Furthermore, although allocations for LTE services may comprise portions as small as 1.25 MHz, it may be desirable to utilize smaller increments (e.g., the minimum resource allocation of one or both services) when considering larger allocations for the LTE service (e.g., allocations between 2.5 MHz and 5.0 MHz or allocations between 5.0 MHz and 10.0 MHz). The exemplary embodiments of the invention describe methods, computer program products, apparatus and systems providing such a shared frequency usage, as explained in further detail below.

FIG. 3 depicts an exemplary 5.0 MHz narrowband deployment for a shared frequency spectrum for GERAN and LTE utilizing aspects of the exemplary embodiments of the invention. As shown in FIG. 3, the 5.0 MHz of available bandwidth has been divided into three portions. Two of the portions comprise the minimum frequency band allocation requirement for the GERAN and LTE services of 2.4 MHz and 1.25 MHz, respectively. The remaining 1.35 MHz of bandwidth comprises a shared portion. The shared portion of bandwidth may be allocated, in part or in whole, to one or both of the two services.

A non-limiting example for determining the allocation of a shared portion for LTE and GERAN integration is presented herein. For this example, assume that the GERAN network is operational and roll-out with full spectrum allocation has been made. Furthermore, assume that the LTE network is introduced to the same dedicated bandwidth of which the GERAN formerly had full use (i.e., a full allocation).

In this example, during rush hour, due to the increase in voice traffic, the speech connections are given a higher priority. As such, additional capacity may be needed for the speech connections. Overall inter-system capacity may be maximized by fully allocating the shared portion to the GERAN system with priority given to speech connections. Mandatory common control channel allocations will remain for both systems to provide at least minimum service capability. Due to the additional bandwidth of the shared portion (as temporarily allocated to the GERAN system), the GERAN service will utilize the BCCH reuse and extend the number of hopping frequencies in the MA lists to encompass the additional bandwidth. In other exemplary embodiments, a longer MA list may be converted into two or more MA lists, thus making it possible to use less than 1/1 reuse for traffic channels.

FIG. 4 shows an exemplary MA list for a GERAN minimum allocation (MA sub) and for an extension into the shared portion of the spectrum (MA full). As apparent in FIG. 4, ARFNs 9-12 have been newly allocated for use by the GERAN service (MA full). The additional ARFNs of the extended MA list (MA full) enable better interference diversity and, thus, higher capacity. In such a manner, the GERAN service could, for example, utilize the shared portion for frequency hopping and increase its capacity beyond the minimum amount. At the same time, the LTE service would retain at least its minimum required frequency allocation of 1.25 MHz.

As a further non-limiting example, assume that rush hour has passed. Speech connection no longer need be assigned a higher priority, thus enabling more capacity to be converted for LTE use. The LTE capacity can be increased by allocating (e.g., temporarily) a portion, or all, of the shared portion to the LTE system. As above, mandatory common control channel allocations will remain for both systems to provide at least minimum service capability. In some exemplary embodiments, the GERAN service may retain BCCH reuse but will now operate with a lower number of hopping frequencies in the MA lists.

Another option for allocating the shared portion comprises multi-layer frequency planning in GERAN, where one of the traffic layers or an extra layer comprises the shared portion. In other exemplary embodiments, the resources may be managed (e.g., in GERAN) using different speech or data codec options. In further exemplary embodiments, automatic link adaptation for codec mode selection may be combined. In other exemplary embodiments, the resources may be managed (e.g., in GERAN) by packing full rate traffic channels, for example, to half or quarter rate traffic channels with multiple sub-channels for an overall higher number of traffic channels. This may be done because the improved link performance with shared spectrum in the high traffic-loaded conditions enables the use of interference control mechanisms (e.g., random frequency hopping, interference rejection mechanisms, micro/macro layer).

In addition to or instead of time-domain processing, further exemplary embodiments utilize other types or forms of multiplexing (e.g., multiplexing in other domains), such as orthogonal sub-channels (multiplexing users in a same modulation constellation) or virtual-MIMO (sharing the same resource and separating by training sequences), as non-limiting examples.

As noted above, the shared portion may also be allocated in part. That is, one part of the shared portion may be allocated for the GERAN service while another part is allocated for the LTE service. Since the GERAN resolution comprises 200 kHz and the LTE resolution comprises 180 kHz, in other exemplary embodiments, the allocations of the shared portion may comprise allocations in 200 kHz increments for the GERAN service and other allocations in 180 kHz increments for the LTE service. If a non-LTE or non-GERAN service is utilized, the allocation for that service may comprises the resolution or minimum resource allocation for that service. In other exemplary embodiments, the shared portion may be allocated to one or both services in increments of a predetermined size, such as the resolution of either one of the two services (e.g., 200 kHz increments) or in 600 kHz increments, as a non-limiting example. In further exemplary embodiments, the increment size may be specified based on the system that is holding the main control logic of the shared spectrum resources. In other exemplary embodiments, the increment size may be specified based on which service comprises traffic having higher or the highest priority. As a non-limiting example, and with specific reference to the above-presented examples of rush hour traffic and GERAN-LTE interoperability, during rush hour traffic, the increment size may be specified as 180 kHz since the speech capacity of the GERAN service has the highest priority at that time (i.e., in high inter-system load conditions, circuit switched speech capacity is not compromised so long as the legacy GSM terminal penetration is relatively high).

As another non-limiting example, with respect to EDGE, 3GPP standardization is currently considering 325 kHz carriers in the UL (e.g., EGPRS2). Thus, the carriers are overlapping. In such cases, it may be beneficial to consider carrier spacing and carrier bandwidth when specifying increment size and allocating resources on a dedicated bandwidth. Note that this wider carrier may also be used in the DL, for example.

Thus, in some exemplary embodiments of the invention, the LTE allocation comprises a portion of the bandwidth equal to (n×180 kHz)+guard band, where n comprises a non-negative integer and n≧6. In other exemplary embodiments, the GERAN allocation comprises a portion of the bandwidth equal to BCCH allocation+(n×200 kHz), where n comprises a non-negative integer and BCCH allocation is 200 kHz×BCCH frequency reuse factor. In some exemplary embodiments, the non-negative integer n may be selected such that the overall bandwidth allocation is substantially utilized or fully utilized in consideration of at least the GERAN BCCH and TCH frequency allocation.

In further exemplary embodiments, the allocation for a service may not exceed the total dedicated bandwidth minus the minimum required bandwidth allocation for other services on the total dedicated bandwidth. In other exemplary embodiments, the allocation for a service may comprise increments allowing the smallest possible bandwidth granularity (e.g., 180 kHz for LTE, 200 kHz for GERAN). In further exemplary embodiments, the allocation for a service may be determined adaptively by a self-engineering algorithm.

In conjunction with the exemplary embodiments of the invention, different BS radio equipment may be used. In other exemplary embodiments, a co-site multi-mode BS is used. Such a co-site multi-mode BS may be used for the same local area having one or more sectors and sites. Antenna lines and installation may be shared between the two systems. In other exemplary embodiments, dedicated antenna and/or radio equipment is used.

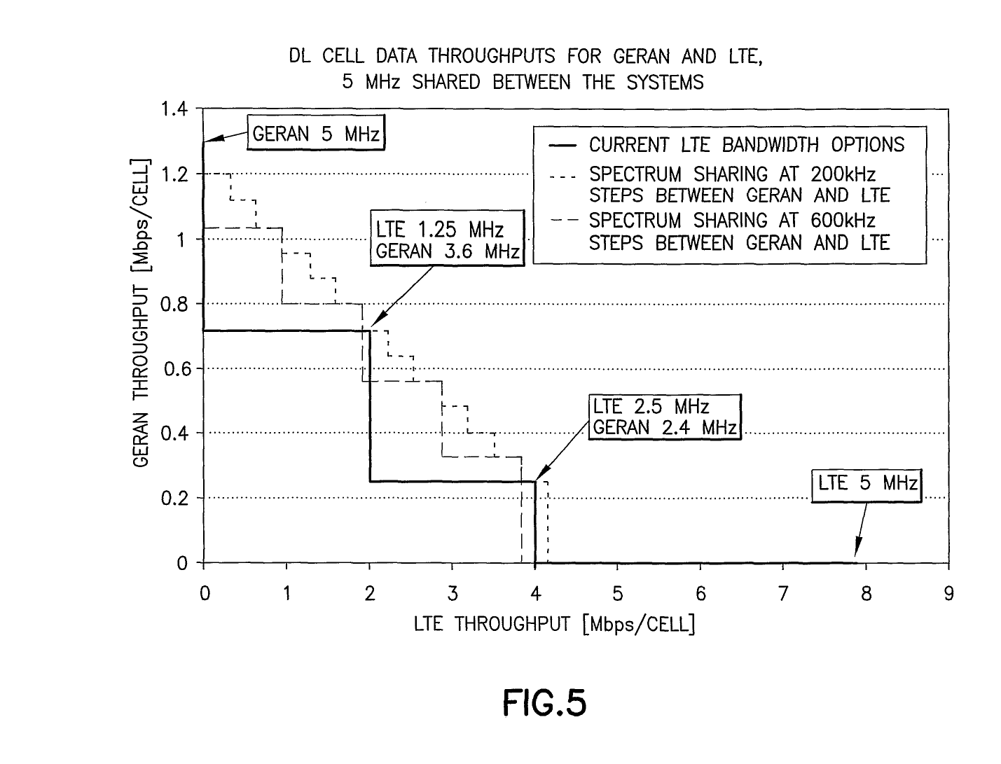

For FIGS. 5-8, a GERAN reuse of 3 is utilized for the hopping layer and it is assumed that the BCCH layer traffic channel has a capacity of 0.1 bits/Hz/s and the TCH layer has a capacity of 0.4 bits/Hz/s. Furthermore, a LTE capacity of 1.6 bits/Hz/s (DL capacity) is assumed. In addition, the 200 kHz-stepped examples correspond to the use of one GSM carrier while the 600 kHz-stepped examples correspond to the use of three GSM carriers (600 kHz=3×200 kHz).

FIG. 5 shows exemplary DL cell data throughputs for GERAN and LTE on a 5 MHz dedicated frequency spectrum. As indicated in FIG. 5, the solid line shows bandwidth options without utilizing a shared portion of bandwidth. There are few options available (four) in such a case, with only two options for coexistence of the two systems. (1) GERAN receives the full 5 MHz and LTE does not receive an allocation (i.e., LTE is inoperative). (2) LTE is allocated 1.25 MHz, leaving 3.6 MHz for GERAN. This results in a reduction of GERAN capacity by approximately 45%. (3) LTE is allocated 2.5 MHz, leaving 2.5 MHz for GERAN. This results in a reduction of GERAN capacity by approximately 80%. (4) LTE receives the full 5 MHz and GERAN does not receive an allocation (i.e., GERAN is inoperative). In this case, additional flexibility for spectrum sharing is desirable to provide more LTE allocation options (e.g., for the portion of bandwidth less than 2.5 MHz).

Also indicated in FIG. 5, with a dashed line, is an exemplary embodiment of the invention utilizing 600 kHz increments (steps) for the shared portion. As can be seen, there are now four intermediate options, enabling stepped reductions in GERAN capacity of about 19%, 38%, 56% and 75%. Utilizing a shared spectrum with 600 kHz steps provides additional options for balancing the capacities of the two systems.

Further indicated in FIG. 5, with a dotted line, is an exemplary embodiment of the invention utilizing 200 kHz increments (steps) for the shared portion. As is apparent, there are now numerous intermediate options for allocating the total bandwidth. This enables more finely-stepped options for reductions in GERAN capacity (with concurrent finely-stepped options for increases in LTE capacity). Using one GSM carrier resolution for LTE-GERAN spectrum sharing enables higher optimization of frequency usage for both networks.

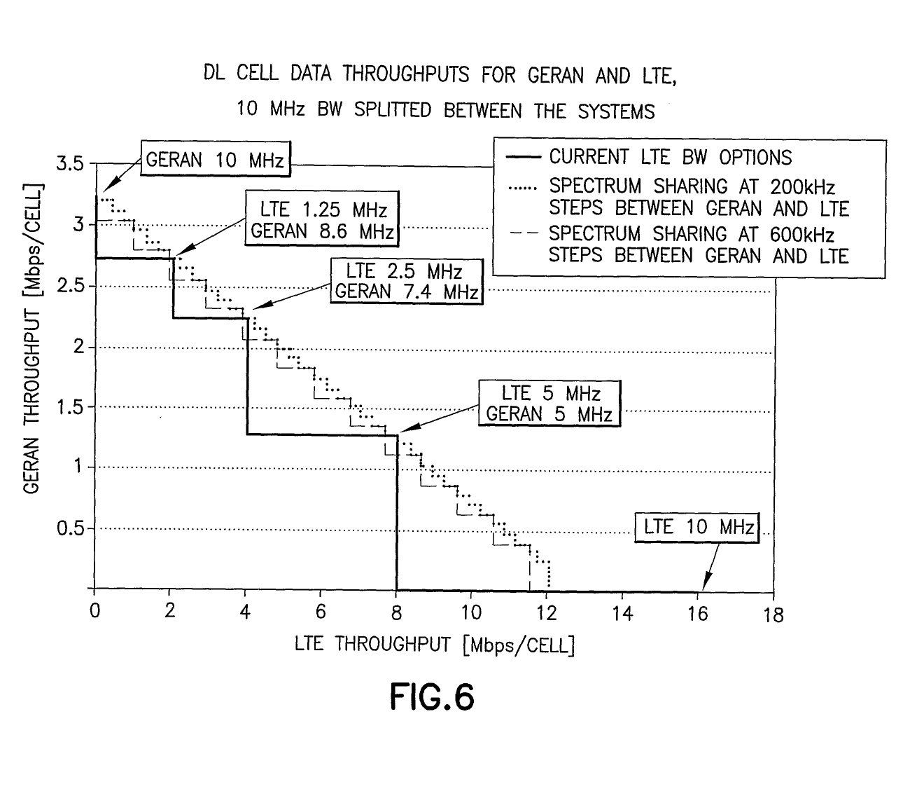

FIG. 6 shows exemplary DL cell data throughputs for GERAN and LTE on a 10 MHz dedicated frequency spectrum. Similar to FIG. 5, the solid line shows bandwidth options without utilizing a shared portion of bandwidth. Three intermediate options are illustrated enabling reductions in GERAN capacity of 17% (1.25 MHz for LTE, 8.6 MHz for GERAN), 32% (2.5 MHz for LTE, 7.4 MHz for GERAN) and 61% (5.0 MHz for LTE, 5.0 MHz for GERAN). In this case, additional flexibility for spectrum sharing is desirable to provide more LTE allocation options (e.g., for the portion of bandwidth greater than 2.5 MHz).

In FIG. 6, the dashed line shows an exemplary embodiment of the invention utilizing 600 kHz increments (steps) for the shared portion and the dotted line shows an exemplary embodiment of the invention utilizing 200 kHz increments (steps) for the shared portion. As is apparent, these two implementations each provide a number of additional intermediate options for sharing the dedicated bandwidth, thus enabling more flexible spectrum sharing.

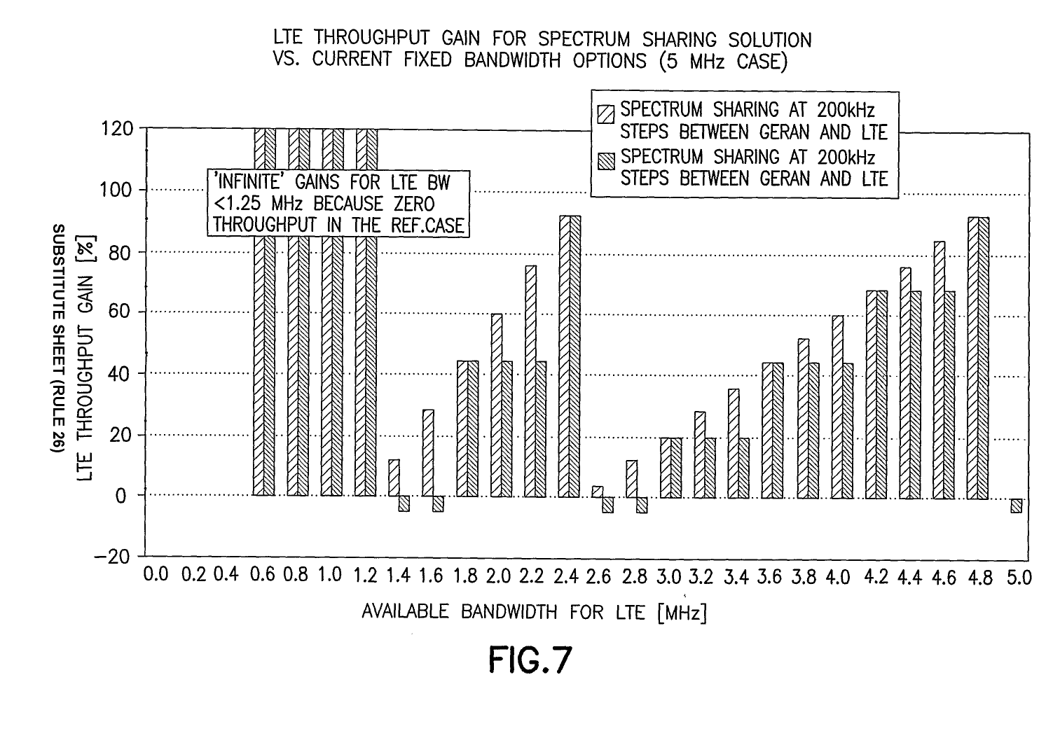

FIG. 7 illustrates a graph of LTE throughput vs. available bandwidth for LTE on a 5 MHz dedicated frequency spectrum for 200 kHz and 600 kHz steps between GERAN and LTE. Note that a minimum LTE band of 0.625 MHz is assumed. On average, LTE throughput improved about 50% for the 200 kHz-stepped spectrum sharing and about 42% for the 600 kHz-stepped spectrum sharing, both as compared to coexistence without stepped spectrum sharing.

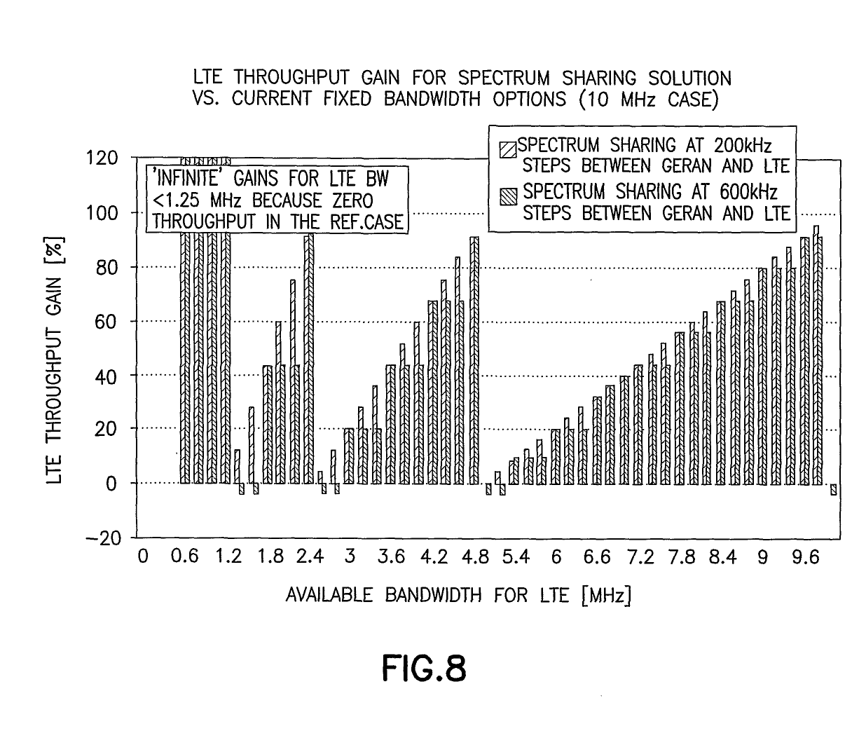

FIG. 8 illustrates a graph of LTE throughput vs. available bandwidth for LTE on a 10 MHz dedicated frequency spectrum for 200 kHz and 600 kHz steps between GERAN and LTE. Again, note that a minimum LTE band of 0.625 MHz is assumed. On average, LTE throughput improved about 49% for the 200 kHz-stepped spectrum sharing and about 43% for the 600 kHz-stepped spectrum sharing, both as compared to coexistence without stepped spectrum sharing.

The 600 kHz-stepped examples of FIGS. 5-8 are presented as a non-limiting example of additional options besides a 200 kHz-stepped implementation. That is, while the 200 kHz accuracy may comprise a beneficial implementation, especially for the GSM service, it may not be as suitable for use with the LTE service, for example, due to complexity in standardization. In such a case, the 600 kHz implementation may comprise a valid, useful option for the GSM service as well as the LTE service. The 200 kHz and 600 kHz implementations, as illustrated in FIGS. 5-8, are presented as non-limiting examples. In other exemplary embodiments, another suitable granularity (i.e., increment, step size) may be used. Note that a smaller granularity may enable more precise inter-system load balancing as compared with a larger granularity. Clearly this is due to the additional intermediate allocations that are made possible by utilization of a smaller granularity.

For FIGS. 7 and 8, as discussed above, note that the minimum resource allocation for the LTE service comprises 0.625 MHz. As noted above, according to the 3GPP, the minimum allocation for the LTE service is currently considered to be 1.25 MHz. “UTRA-UTRAN Long Term Evolution (LTE) and 3GPP System Architecture Evolution (SAE), Long Term Evolution of the 3GPP radio technology,” 3GPP, updated Oct. 4, 2006. However, as also noted above, LTE is still under review by the 3GPP and the currently-specified attributes are subject to change. That is, FIGS. 7 and 8 illustrate an exemplary system in which the minimum LTE allocation comprise 0.625 MHz. Due to this, the throughput gain in LTE for the allocations from 0.625 MHz to 1.25 MHz are “infinite”, as displayed in the figures.

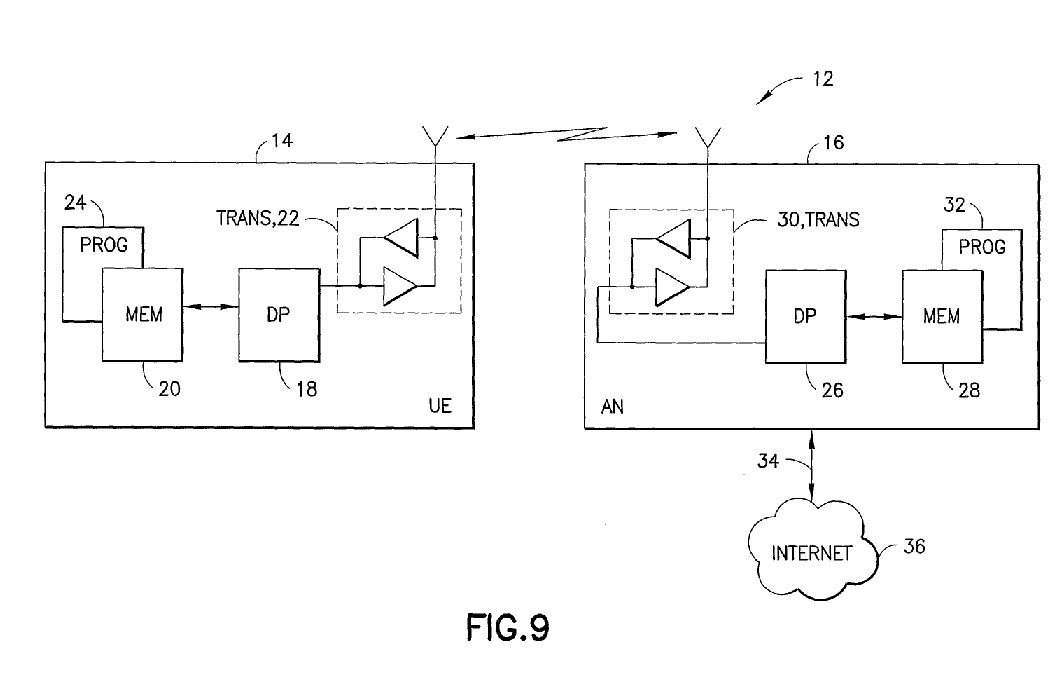

Reference is made to FIG. 9 for illustrating a simplified block diagram of various electronic devices that are suitable for use in practicing the exemplary embodiments of this invention. In FIG. 9, a wireless network 12 is adapted for communication with a user equipment (UE) 14 via an access node (AN) 16. The UE 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for bidirectional wireless communications with the AN 16. Note that the TRANS 22 has at least one antenna to facilitate communication.

The AN 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for bidirectional wireless communications with the UE 14. Note that the TRANS 30 has at least one antenna to facilitate communication. The AN 16 is coupled via a data path 34 to one or more external networks or systems, such as the internet 36, for example. At least one of the PROGs 24, 32 is assumed to include program instructions that, when executed by the associated DP, enable the electronic device to operate in accordance with the exemplary embodiments of this invention, as discussed herein.

In general, the various embodiments of the UE 14 can include, but are not limited to, mobile terminals, mobile phones, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by one or more of the DPs 18, 26 of the UE 14 and the AN 16, or by hardware, or by a combination of software and hardware.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples. The DPs 18, 26, or another suitable component, may be configured to perform one or more measurements, such as measuring one or more attributes of the network (e.g., network load, network load per system type), as a non-limiting example.

The exemplary embodiments of the invention describe methods, computer program products, apparatus and systems providing for shared frequency usage. As can be seen, the exemplary embodiments of the invention allow for integrating (e.g., otherwise conflicting) wireless communication services or systems that use, or have the potential for using, a same dedicated bandwidth, where each of the services or systems has a minimum capacity requirement (e.g., a minimum bandwidth allocation required for operation of the service or system), by providing for a shared portion of the dedicated bandwidth. Furthermore, the exemplary embodiments of the invention enable flexible allocations such that the shared portion can be allocated based on criteria (e.g., the relative traffic of the systems).

Specifically, the exemplary embodiments of the invention also provide for integration of LTE on a GERAN dedicated bandwidth by using a shared portion of bandwidth that may be allocated, in part or in whole, to one or both of the two systems. In a LTE-GERAN implementation, since LTE comprises only packet-switched channels, other GERAN quality of service measures, in addition to average reception quality, may be considered, such as delay of data packets, data throughput and transmission reliability, as non-limiting examples.

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments.

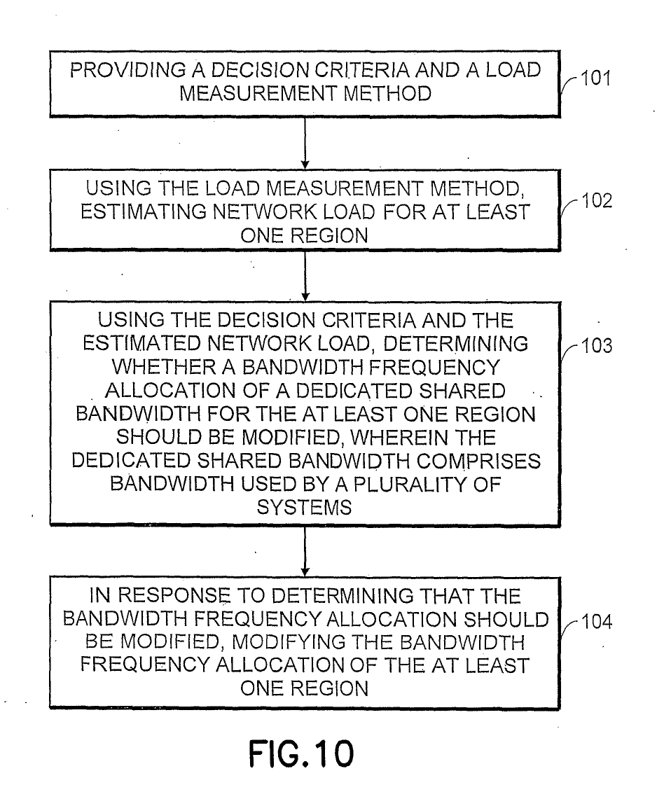

1. In one non-limiting, exemplary embodiment, and as illustrated in FIG. 10, a method includes: providing a decision criteria and a load measurement method (101); using the load measurement method, estimating network load for at least one region (102); using the decision criteria and the estimated network load, determining whether a bandwidth frequency allocation of a dedicated shared bandwidth for the at least one region should be modified, wherein the dedicated shared bandwidth comprises bandwidth used by a plurality of systems (103); and, in response to determining that the bandwidth frequency allocation should be modified, modifying the bandwidth frequency allocation of the at least one region (104).

A method as above, wherein the estimating of the network load comprises at least one measurement of at least one attribute of the at least one region (e.g., traffic). A method as in any above, wherein modifying the bandwidth frequency allocation comprises starting a multi-mode channel allocation process within the dedicated shared bandwidth. A method as in any above, wherein modifying the bandwidth frequency allocation comprises adjusting channel assignments for the at least one region. A method as in any above, wherein the bandwidth frequency allocation is modified such that the bandwidth frequency allocation is substantially or fully allocated to the plurality of systems. A method as in any above, wherein the plurality of systems comprises at least two systems using different communication technologies. A method as in any above, wherein the plurality of systems comprises a GERAN system and a LTE system. A method as in any above, wherein the at least one region comprises at least one sector, site or cell. Load measurement methods, measures of network load and further types of decision criteria are known by one of ordinary skill in the art.

A method as in any above, wherein determining whether the bandwidth frequency allocation should be modified comprises monitoring the network load. A method as in any above, wherein the network load is monitored using available RRM tools or key performance indicators. A method as in any above, wherein the plurality of systems comprises a GERAN system and wherein average reception quality for speech connection indicates whether the GERAN system is heavily loaded. A method as in any above, wherein estimating network load comprises considering at least one of average reception quality, delay of data packets, data throughput and transmission reliability.

A method as in any above, wherein estimating the network load comprises measuring an average number of free time slots. A method as in any above, wherein determining whether the bandwidth frequency allocation should be modified comprises comparing the measured average number of free time slots to a number of occupied time slots. A method as in any above, wherein the comparison indicates that more or less capacity should be provided to one system. A method as in any above, wherein determining whether the bandwidth frequency allocation should be modified comprises comparing an average system load to statistical network data (e.g., for the time or time period). A method as in any above, wherein the method is implemented by a computer program.

2. In another non-limiting, exemplary embodiment, and as illustrated in FIG. 12, a method includes: estimating network load for at least one region of a network using a load measurement method (201); using a decision criteria and the estimated network load, determining whether a bandwidth frequency allocation of a dedicated shared bandwidth for the at least one region should be modified, wherein the dedicated shared bandwidth comprises bandwidth used by a plurality of systems of the network (202); and in response to determining that the bandwidth frequency allocation should be modified, modifying the bandwidth frequency allocation of the at least one region (203).

A method as above, wherein the estimating of the network load comprises making at least one measurement of at least one attribute of the at least one region. A method as in any above, wherein modifying the bandwidth frequency allocation comprises starting a multi-mode channel allocation process within the dedicated shared bandwidth. A method as in any above, wherein modifying the bandwidth frequency allocation comprises adjusting channel assignments for the at least one region. A method as in any above, wherein the plurality of systems comprises at least two systems using different communication technologies. A method as in any above, wherein the plurality of systems comprises a global system for mobile communications (GSM)/enhanced data rates for GSM evolution (EDGE) radio access network and a long term evolution of universal terrestrial radio access network.

A method as in any above, wherein determining whether the bandwidth frequency allocation should be modified comprises monitoring the network load. A method as in the previous, wherein the network load is monitored using available radio resource management tools or key performance indicators. A method as in any above, wherein estimating network load comprises considering at least one of average reception quality, delay of data packets, data throughput and transmission reliability. A method as in any above, wherein estimating the network load comprises measuring an average number of free time slots. A method as in any above, wherein determining whether the bandwidth frequency allocation should be modified comprises comparing a measured average number of free time slots to a number of occupied time slots. A method as in any above, wherein determining whether the bandwidth frequency allocation should be modified comprises comparing an average system load to statistical network data. A method as in any above, wherein the method is implemented by a computer program.

3. In another non-limiting, exemplary embodiment, a program storage device readable by a machine, tangibly embodying a program of instructions executable by the machine for performing operations, said operations comprising: estimating network load for at least one region of a network using a load measurement method (201); using a decision criteria and the estimated network load, determining whether a bandwidth frequency allocation of a dedicated shared bandwidth for the at least one region should be modified, wherein the dedicated shared bandwidth comprises bandwidth used by a plurality of systems of the network (202); and in response to determining that the bandwidth frequency allocation should be modified, modifying the bandwidth frequency allocation of the at least one region (203).

A program storage device as above, wherein the estimating of the network load comprises making at least one measurement of at least one attribute of the at least one region. A program storage device as in any above, wherein modifying the bandwidth frequency allocation comprises starting a multi-mode channel allocation process within the dedicated shared bandwidth. A program storage device as in any above, wherein modifying the bandwidth frequency allocation comprises adjusting channel assignments for the at least one region. A program storage device as in any above, wherein the plurality of systems comprises at least two systems using different communication technologies. A program storage device as in any above, wherein the plurality of systems comprises a global system for mobile communications (GSM)/enhanced data rates for GSM evolution (EDGE) radio access network and a long term evolution of universal terrestrial radio access network. A program storage device as in any above, wherein estimating network load comprises considering at least one of average reception quality, delay of data packets, data throughput and transmission reliability.

A program storage device as in any above, wherein determining whether the bandwidth frequency allocation should be modified comprises monitoring the network load. A program storage device as in the previous, wherein the network load is monitored using available radio resource management tools or key performance indicators. A program storage device as in any above, wherein estimating the network load comprises measuring an average number of free time slots. A program storage device as in any above, wherein determining whether the bandwidth frequency allocation should be modified comprises comparing a measured average number of free time slots to a number of occupied time slots. A program storage device as in any above, wherein determining whether the bandwidth frequency allocation should be modified comprises comparing an average system load to statistical network data.

4. In another non-limiting, exemplary embodiment, an apparatus (16) comprising: a memory (28) configured to store a decision criteria; and a processor (26) configured to estimate network load for at least one region of a network using a load measurement method, to use the decision criteria and the estimated network load to determine whether a bandwidth frequency allocation of a dedicated shared bandwidth for the at least one region should be modified, and, in response to determining that the bandwidth frequency allocation should be modified, to modify the bandwidth frequency allocation of the at least one region, wherein the dedicated shared bandwidth comprises bandwidth used by a plurality of systems of the network.

An apparatus as above, wherein the processor (26) estimating the network load comprises the processor (26) making at least one measurement of at least one attribute of the at least one region. An apparatus as in any above, wherein the processor (26) modifying the bandwidth frequency allocation comprises the processor starting a multi-mode channel allocation process within the dedicated shared bandwidth. An apparatus as in any above, wherein the processor (26) modifying the bandwidth frequency allocation comprises the processor (26) adjusting channel assignments for the at least one region. An apparatus as in any above, wherein the plurality of systems comprises at least two systems using different communication technologies. An apparatus as in any above, wherein the plurality of systems comprises a global system for mobile communications (GSM)/enhanced data rates for GSM evolution (EDGE) radio access network and a long term evolution of universal terrestrial radio access network. An apparatus as in any above, wherein the processor (26) estimating network load comprises the processor (26) considering at least one of average reception quality, delay of data packets, data throughput and transmission reliability. An apparatus as in any above, wherein the apparatus comprises a base station.

An apparatus as in any above, wherein the processor (26) determining whether the bandwidth frequency allocation should be modified comprises the processor (26) monitoring the network load. An apparatus as in the previous, wherein the network load is monitored using available radio resource management tools or key performance indicators. An apparatus as in any above, wherein the processor (26) estimating the network load comprises the processor (26) measuring an average number of free time slots. An apparatus as in any above, wherein the processor (26) determining whether the bandwidth frequency allocation should be modified comprises the processor (26) comparing a measured average number of free time slots to a number of occupied time slots. An apparatus as in any above, wherein the processor (26) determining whether the bandwidth frequency allocation should be modified comprises the processor (26) comparing an average system load to statistical network data.

5. In another non-limiting, exemplary embodiment, an apparatus comprising: means for estimating network load for at least one region of a network using a load measurement method; means for using a decision criteria and the estimated network load to determine whether a bandwidth frequency allocation of a dedicated shared bandwidth for the at least one region should be modified, wherein the dedicated shared bandwidth comprises bandwidth used by a plurality of systems of the network; and means for modifying, in response to the means for determining that the bandwidth frequency allocation should be modified, the bandwidth frequency allocation of the at least one region.

An apparatus as above, wherein the means for estimating, the means for using and the means for modifying comprise a processor. An apparatus as in any above, further comprising means for storing the decision criteria. An apparatus as in the previous, wherein the means for storing comprises a memory. An apparatus as in any above, wherein the apparatus comprises a base station.

An apparatus as above, further comprising means for making at least one measurement of at least one attribute of the at least one region, wherein said at least one measurement is utilized by said means for estimating. An apparatus as in any above, wherein the means for modifying the bandwidth frequency allocation is further for starting a multi-mode channel allocation process within the dedicated shared bandwidth. An apparatus as in any above, wherein the means for modifying the bandwidth frequency allocation is further for adjusting channel assignments for the at least one region. An apparatus as in any above, wherein the plurality of systems comprises at least two systems using different communication technologies. An apparatus as in any above, wherein the plurality of systems comprises a global system for mobile communications (GSM)/enhanced data rates for GSM evolution (EDGE) radio access network and a long term evolution of universal terrestrial radio access network. An apparatus as in any above, wherein the means for estimating network load is further for considering at least one of average reception quality, delay of data packets, data throughput and transmission reliability.

An apparatus as in any above, wherein the means for determining whether the bandwidth frequency allocation should be modified is further for monitoring the network load. An apparatus as in the previous, wherein the network load is monitored using available radio resource management tools or key performance indicators. An apparatus as in any above, wherein the means for estimating the network load is further for measuring an average number of free time slots. An apparatus as in any above, wherein the means for determining whether the bandwidth frequency allocation should be modified is further for comparing a measured average number of free time slots to a number of occupied time slots. An apparatus as in any above, wherein the means for determining whether the bandwidth frequency allocation should be modified is further for comparing an average system load to statistical network data.

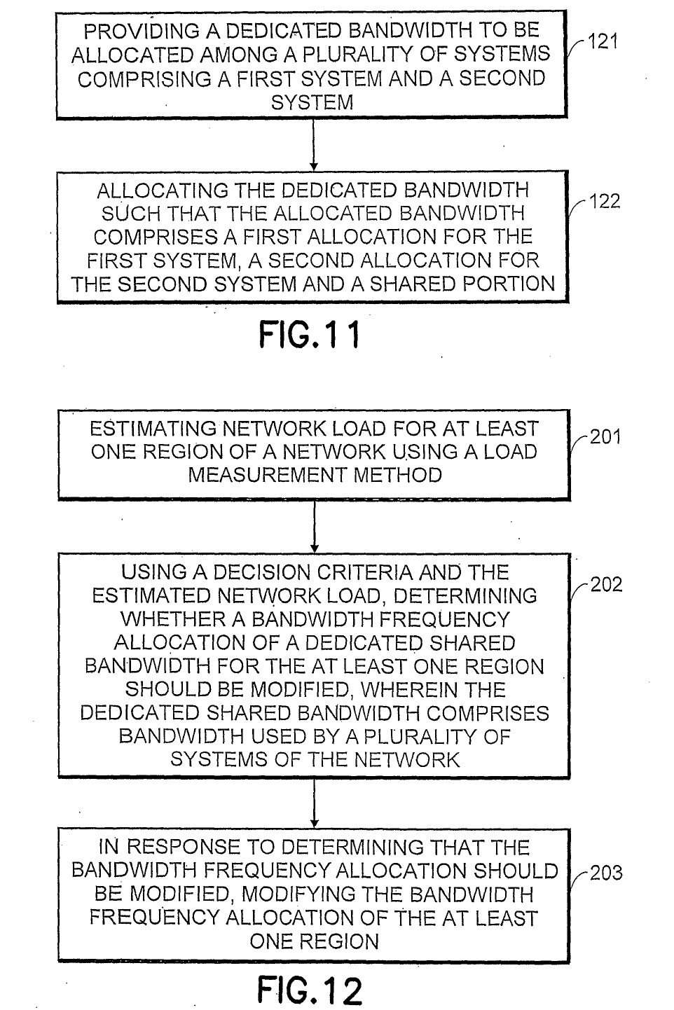

6. In another non-limiting, exemplary embodiment, and as illustrated in FIG. 11, a method includes: providing a dedicated bandwidth to be allocated among a plurality of systems comprising a first system and a second system (121); and allocating the dedicated bandwidth such that the allocated bandwidth comprises a first allocation for the first system, a second allocation for the second system and a shared portion (122).

A method as in any above, wherein the shared portion is allocated to the first system or the second system. A method as in any above, wherein, in response to a first condition being met, the shared portion is substantially allocated to the first system. A method as in the previous, wherein the first condition comprises an increase in traffic for the first system. A method as in any above, wherein, in response to a second condition being met, the shared portion is reallocated between the first system and the second system. A method as in any above, wherein the method is implemented by a base station of the network. A method as in any above, wherein the method is implemented by a computer program.

7. In another non-limiting, exemplary embodiment, a program storage device readable by a machine, tangibly embodying a program of instructions executable by the machine for performing operations, said operations comprising: providing a dedicated bandwidth to be allocated among a plurality of systems of a network, wherein the plurality of systems comprises a first system and a second system; and allocating the dedicated bandwidth such that the allocated bandwidth comprises a first allocation for the first system, a second allocation for the second system and a shared portion.

A program storage device as in any above, wherein the shared portion is allocated to the first system or the second system. A program storage device as in any above, wherein, in response to a first condition being met, the shared portion is substantially allocated to the first system. A program storage device as in the previous, wherein the first condition comprises an increase in traffic for the first system. A program storage device as in any above, wherein, in response to a second condition being met, the shared portion is reallocated between the first system and the second system. A program storage device as in any above, wherein the machine comprises a base station of the network.

8. In another non-limiting, exemplary embodiment, an apparatus (16) comprising: a processor (26) configured to allocate a dedicated bandwidth in a network such that the allocated bandwidth comprises a first allocation for a first system, a second allocation for a second system and a shared portion; and a memory (28) configured to store allocation information for the allocated dedicated bandwidth.

An apparatus (16) as in any above, wherein the shared portion is allocated to the first system or the second system. An apparatus (16) as in any above, wherein, in response to a first condition being met, the shared portion is substantially allocated to the first system. An apparatus (16) as in the previous, wherein the first condition comprises an increase in traffic for the first system. An apparatus (16) as in any above, wherein, in response to a second condition being met, the shared portion is reallocated between the first system and the second system. An apparatus (16) as in any above, wherein the apparatus comprises a base station of the network.

9. In another non-limiting, exemplary embodiment, an apparatus comprising: means for allocating a dedicated bandwidth in a network such that the allocated bandwidth comprises a first allocation for a first system, a second allocation for a second system and a shared portion; and means for storing allocation information for the allocated dedicated bandwidth.

An apparatus as in any above, wherein the shared portion is allocated to the first system or the second system. An apparatus as in any above, wherein, in response to a first condition being met, the shared portion is substantially allocated to the first system. An apparatus as in the previous, wherein the first condition comprises an increase in traffic for the first system. An apparatus as in any above, wherein, in response to a second condition being met, the shared portion is reallocated between the first system and the second system. An apparatus as in any above, wherein the apparatus comprises a base station of the network. An apparatus as in any above, wherein the means for allocating comprises a processor and the means for storing comprises a memory.

The exemplary embodiments of the invention, as discussed above and as particularly described herein with respect to exemplary methods, may be implemented as a computer program product comprising program instructions embodied on a tangible computer-readable medium. Execution of the program instructions results in operations comprising the steps of utilizing the exemplary embodiments or the steps of the method.

The exemplary embodiments of the invention, as discussed above and as particularly described with respect to exemplary methods, may be implemented in conjunction with a program storage device readable by a machine, tangibly embodying a program of instructions executable by the machine for performing operations. The operations comprise steps of utilizing the exemplary embodiments or steps of the method.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The exemplary embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the preferred embodiments of this invention could be used to advantage without the corresponding use of other features. As such, the foregoing description should be considered as merely illustrative of the principles, teachings and exemplary embodiments of this invention, and not in limitation thereof.

1-35. (canceled)

36. A method comprising:
estimating network load for at least one region of a network using a load measurement method;
using a decision criteria and the estimated network load, determining whether a bandwidth frequency allocation of a dedicated shared bandwidth for the at least one region should be modified, wherein the dedicated shared bandwidth comprises bandwidth used by a plurality of systems of the network; and
in response to determining that the bandwidth frequency allocation should be modified, modifying the bandwidth frequency allocation of the at least one region.

37. A method as in claim 36, wherein the estimating of the network load comprises making at least one measurement of at least one attribute of the at least one region.

38. A method as in claim 36, wherein modifying the bandwidth frequency allocation comprises starting a multi-mode channel allocation process within the dedicated shared bandwidth.

39. A method as in claim 36, wherein modifying the bandwidth frequency allocation comprises adjusting channel assignments for the at least one region.

40. A method as in claim 36, wherein the plurality of systems comprises at least two systems using different communication technologies.

41. A method as in claim 40, wherein the plurality of systems comprises a global system for mobile communications (GSM)/enhanced data rates for GSM evolution (EDGE) radio access network and a long term evolution of universal terrestrial radio access network.

42. A method as in claim 36, wherein determining whether the bandwidth frequency allocation should be modified comprises monitoring the network load.

43. A method as in claim 36, wherein estimating network load comprises considering at least one of average reception quality, delay of data packets, data throughput and transmission reliability.

44. A method as in claims 36, wherein estimating the network load comprises measuring an average number of free time slots.

45. A method as in claim 36, wherein determining whether the bandwidth frequency allocation should be modified comprises comparing a measured average number of free time slots to a number of occupied time slots.

46. A method as in claim 36, wherein determining whether the bandwidth frequency allocation should be modified comprises comparing an average system load to statistical network data.

47. A program storage device readable by a machine, tangibly embodying a program of instructions executable by the machine for performing operations, said operations comprising:
estimating network load for at least one region of a network using a load measurement method;
using a decision criteria and the estimated network load, determining whether a bandwidth frequency allocation of a dedicated shared bandwidth for the at least one region should be modified, wherein the dedicated shared bandwidth comprises bandwidth used by a plurality of systems of the network; and
in response to determining that the bandwidth frequency allocation should be modified, modifying the bandwidth frequency allocation of the at least one region.

48. An apparatus comprising:
a memory configured to store a decision criteria; and
a processor configured to estimate network load for at least one region of a network using a load measurement method, to use the decision criteria and the estimated network load to determine whether a bandwidth frequency allocation of a dedicated shared bandwidth for the at least one region should be modified, and, in response to determining that the bandwidth frequency allocation should be modified, to modify the bandwidth frequency allocation of the at least one region, wherein the dedicated shared bandwidth comprises bandwidth used by a plurality of systems of the network.

49. An apparatus as in claim 48, wherein the processor estimating the network load comprises the processor making at least one measurement of at least one attribute of the at least one region.

50. An apparatus as in claim 48, wherein the processor modifying the bandwidth frequency allocation comprises the processor starting a multi-mode channel allocation process within the dedicated shared bandwidth.

51. An apparatus as in claim 48, wherein the processor modifying the bandwidth frequency allocation comprises the processor adjusting channel assignments for the at least one region.

52. An apparatus as in claim 48, wherein the plurality of systems comprises at least two systems using different communication technologies.

53. An apparatus as in claim 52, wherein the plurality of systems comprises a global system for mobile communications (GSM)/enhanced data rates for GSM evolution (EDGE) radio access network and a long term evolution of universal terrestrial radio access network.

54. An apparatus as in claim 48, wherein the processor estimating network load comprises the processor considering at least one of average reception quality, delay of data packets, data throughput and transmission reliability.

55. An apparatus as in claim 48, wherein the apparatus comprises a base station.
